(19) United States
(12) Patent Application Publication
(10) Pub. No.: US 2024/0381947 A1
(43) Pub. Date: Nov. 21, 2024

(54) A TESTING EQUIPMENT AND METHOD FOR TESTING A HEATING ELEMENT IN AN AEROSOL-GENERATING ARTICLE

(71) Applicant: PHILIP MORRIS PRODUCTS S.A., Neuchatel (CH)

(72) Inventors: Jerome Christian Courbat, Cortaillod (CH); Mario Antonio Francese, Milvignes (CH); Andreas Michael Rossoll, Le Mont-sur-Lausanne (CH); Johann Friedrich Schmidt, Dorschhausen (DE); Alain Comtesse, Cernier (CH)

(21) Appl. No.: 18/704,163

(22) PCT Filed: Oct. 24, 2022
(86) PCT No.: PCT/EP2022/079526

§ 371 Date: Apr. 24, 2024

(30) Foreign Application Priority Data
Oct. 25, 2021 (EP) 21204407.7

(51) Int. Cl. A24F 40/80; A24F 40/465

(52) U.S. Cl. CPC A24F 40/80; A24F 40/465

(57) ABSTRACT

The present invention relates to a non-destructive testing equipment and method for testing a heating element in an aerosol-generating article. The testing equipment comprises a control module comprising a passage for an aerosol-generating article to pass the control module through the passage. The control module further comprises a control circuit and a measurement device. The control circuit comprises an excitation coil configured to generate an alternating magnetic field within the passage of the control module. The measurement device is configured to determine values related to a load applied to the control circuit responsive to physical characteristics of the heating element, when the heating element passes the control module through the passage. The control module is further configured to determine if a determined value of the tested heating element corresponds to a predefined value of a predefined heating element.

The present invention relates to a non-destructive testing equipment and method for testing a heating element in an article comprising said heating element.

Articles comprising an aerosol-forming substrate and a heating element for heating the substrate to generate aerosol are generally known from prior art. In particular, in inductively heatable articles comprising a susceptor as heating element, material parameters of the susceptor need to be within very specific ranges for an optimized performance of the heating element. However, testing the article under real conditions, thus testing the performance of the heating element while being heated is time consuming and renders the article unusable.

Therefore, there is a need for a testing equipment and testing method allowing a non-destructive and fast testing of a heating element in an aerosol-generating article comprising the heating element.

According to the invention there is provided a non-destructive testing equipment for testing a heating element in an aerosol-generating article. The testing equipment comprises a control module comprising a passage for an aerosol-generating article to pass the control module through the passage. The control module further comprises a control circuit and a measurement device. The control circuit comprises an excitation coil configured to generate an alternating magnetic field within the passage of the control module, and the measurement device is configured to determine values related to a load applied to the control circuit responsive to physical characteristics of the heating element, when the heating element passes the control module through the passage. The control module is further configured to determine if a determined value of the tested heating element corresponds to a predefined value of a predefined heating element.

The testing equipment allows an article to be tested while the article passes through the testing equipment in a passage in the testing equipment. An excitation coil in a control module is activated and a response of the article may be measured in a measurement device of the control module. The response is characteristic of material parameters of the heating element, in particular of its apparent resistance.

This testing allows for a very fast testing of a heating element, while the tested article may further be used.

Preferably, values representing physical characteristics of the heating element are permeability, apparent electrical resistance values or apparent electrical conductance values and the predefined value of a heating element are predefined permeability, predefined electrical resistance or electrical conductance values. Most preferable, values representing physical characteristics of the heating element are apparent electrical resistance values and the predefined values are predefined electrical resistance values.

Preferably, the determined value is a value indicative of an apparent electrical resistance of the heating element.

A detected or measured resistance typically corresponds to the resistance of the system, in particular to the resistance of the excitation coil and of the resistance of the heating element. From the measured value, the known resistance of the excitation coil may be subtracted to get the resistance values of the heating element.

The measurement device may comprise a current measurement device for determining a DC current drawn by the control circuit from a DC power supply of the device. The measurement device is configured to determine an electrical resistance value of the control circuit from a ratio of the determined DC current to a DC voltage applied to the control circuit.

In the testing equipment, the excitation coil may be part of an LRC circuit of the measurement device.

The control circuit of the control module is configured to power the excitation coil. In particular, the control circuit is configured to provide power pulses for powering the excitation coil. Preferably, the control circuit is configured to operate the excitation coil at low power. By this, any possible heating of the heating element, in particular heat generation by eddy currents in a resistive material of a heating element, is prevented. Preferably, the control circuit is configured to apply a DC voltage to the control circuit in a range between 0.5 V and 3V, preferably 1 V.

DC voltages in this power range have provided good testing results thus acceptable measurement values and no heating of the heating element. In particular, good testing results were achieved with LRC parameters with a magnetic inductance L in a range between about 0.1 microhenry and 0.15 microhenry, for example 0.12 microhenry, and an electrical resistance R of the excitation coil (background) in a range between about 38 milliohms and 43 milliohms, for example between 40 milliohms and 41 milliohms.

Preferably, the control module is configured to output acceptance of the aerosol-forming article, when the determined value of the tested heating element corresponds to the predefined value of the predefined heating element. Preferably, the control module is configured to output rejection of the aerosol-generating article, when the determined value of the tested heating element does not correspond to the predefined value of the predefined heating element.

‘Corresponding to’ is herein defined as corresponding to the exact value of the predefined value and to a value within a predefined threshold of plus or minus 20 percent of the predefined value, more preferably within a predefined threshold of plus or minus 10 percent of the predefined value.

Preferably, the excitation coil is arranged in the control module and arranged to surround the passage. By this, the article to be tested may be guided through the center of the excitation coil. Preferably, the article passes the excitation coil along a central longitudinal axis of the excitation coil.

The passage in the control module is a path in the control module, where the aerosol-generating article may be guided along and wherein the article is made to pass the excitation coil and measurement device of the control module along this path. The path may be open or closed along its way through the control module. Preferably, the passage in the control module is a through-hole through the control module.

A passage has open ends and allows an article to pass undisturbedly through the control module. Preferably, a diameter of a passage, in particular of a through-hole, is between about 10 percent and 50 percent larger than a diameter of the article to be tested and passing through the passage.

Preferably, a passage partially or entirely surrounds an article passing through the passage.

Preferably, a passage has a tubular shape.

Preferably, the passage is formed as a tube in the control module.

Preferably, a passage has a circular or oval cross-section.

The testing equipment may further comprise a guide element for guiding the aerosol-generating article to the passage of the control module. The guide element may comprise a conveyor for conveying the aerosol-generating article to and preferably also through the control module. Alternatively, or in addition, the guide element may comprise a slide for guiding the aerosol-generating article on the slide to the passage of the control module. Preferably, a slide is provided when articles are guided to the control module by gravitational force only.

The guide element may comprise converging guides converging versus an opening of the passage. Such converging guides may support an exact guiding of a single article to the opening of the passage, in particular to a center of the opening of the passage.

The testing equipment may further comprise a reservoir for holding aerosol-generating articles, the reservoir being arranged upstream of the control module. With the provision of a reservoir, a plurality of articles may subsequently and in a fast manner be delivered to the testing equipment, thus allowing for a fast testing sequence of article. A reservoir may, for example, comprise articles of a same batch of articles, to be tested. With a reservoir, the testing equipment may be operated continuously or automatically, possibly only needing personnel for filling the reservoir.

The testing equipment may be a stand-alone device for testing articles comprising a heating element, for example articles being a multiple of a segment of a final consumable, being a segment of a final consumable, or being a final consumable, such as for example a heat stick.

The testing equipment may be integrated into a manufacturing process of aerosol-generating articles, for example articles as parts of final consumables such as heat sticks, or in a manufacturing process of final consumable, such as heat sticks. The testing equipment is then used for testing finished or semi-finished products, wherein the testing is integrated in a manufacturing process.

For example, an article may be a rod-shaped plug of aerosol-forming substrate, for example a tobacco plug, comprising a heating element. The plug may be a final plug of a heat stick used in combination with an electronic aerosol-generating device, preferably an inductively heatable aerosol-generating device.

In some preferred embodiments, the testing equipment is arranged between article manufacturing components. Article manufacturing components may, for example, be any one of a rod-forming device and a cutting device arranged upstream of the testing equipment. The article manufacturing components may, for example, be any one of a cutting device, an article storage and an article packaging device arranged downstream of the testing device.

The invention also relates to a non-destructive testing method for testing a heating element in an aerosol-generating article. The method comprises providing an aerosol-generating article comprising a heating element, letting the aerosol-generating article pass an alternating magnetic field of a control circuit without heating the heating element, determining values related to a load by the heating element applied to the control circuit responsive to physical characteristics of the heating element passing the alternating field of the control circuit; and comparing a determined value of the tested heating element with a predefined value of a predefined heating element.

The method may further comprise the steps of accepting the aerosol-generating article, if a difference between the determined value of the tested heating element and the predefined value is within a predefined threshold or rejecting the aerosol-generating article, if a difference between the determined value of the tested heating element and the predefined value exceeds the predefined threshold.

Preferably, the method comprised determining values indicative of the apparent electrical resistance of the heating element.

In some embodiments, the method comprises measuring a DC current drawn by the control circuit from a DC power supply, and determining an apparent electric resistance value of the control circuit from a ratio of the determined DC current to a DC voltage applied to the control circuit.

For performing a measurement, the method comprises providing power pulses from the control module to the excitation coil.

Preferably, the method comprises applying a DC voltage of between 0.5 V and 3V to the control circuit.

The testing of the aerosol-generating article may be performed while the article is stationary during the measurement. In these embodiments, the article is moved to the control unit of the testing equipment, guided into the passage, stopped therein for performing the measurement and then moved out of the passage. Having moving articles but a stationary testing may improve precision of the testing results, while at the same time still having a fast testing of a plurality of articles.

Preferably, the article is moving through the passage while being tested. Testing of moving articles, preferably of continuously moving articles, allows for a very fast testing of a high number of articles. While fast testing may not be as precise as slow testing, the fast testing is getting more precise the more defective a heating element is. Thus, the fast testing is well suitable to recognise very ‘bad’ heating elements.

In the method according to the invention, the aerosol-generating article may pass the alternating magnetic field with a velocity between 0 m/s and 40 m/s, when being tested.

Preferably, the aerosol-generating article passes the alternating magnetic field with a velocity between 10 m/s and 30 m/s, when being tested.

Preferably, the aerosol-generating article is passing through a center of the excitation coil.

A co-centrical arrangement of article and excitation coil may reduce irregularities in the excitation of the material of the heating element when temporarily being arranged in the excitation coil or passing the excitation coil. Preferably, heating element and excitation coil have a symmetric arrangement when the article is passing the excitation coil.

Preferably, the method comprises guiding the aerosol-generating article to the center of the excitation coil. By this, the article enters the excitation coil at the center and may then pass along the longitudinal axis of the excitation coil through the control unit. Thereby, the aerosol-generating article may be transported through the alternating magnetic field by transportation means, for example by means of a conveyor, such as a conveyor belt. Alternatively, the aerosol-generating article is falling through the alternating magnetic field due to gravitational force.

In some embodiments the method may further comprise providing a reservoir comprising aerosol-generating articles comprising a heating element and guiding the aerosol-generating articles from the reservoir to the alternating magnetic field.

Preferably, the aerosol-generating article is rod-shaped. More preferably, the aerosol-generating article is a rod-shaped aerosol-generating substrate comprising the heating element.

The aerosol-generating article may have a final length of a tobacco plug of a consumable being used in an aerosol-generating device. The aerosol-generating article may have a multiple length of a final length of a tobacco plug of a consumable being used in an aerosol-generating device. Accordingly, the method may comprise the step of adapting the predefined value of a predefined heating element according a length of the predefined heating element. Depending on the amount of electrically conductive material in the article representing the heating element and being present in the excitation coil, a load of the control circuit varies and with this an according response of the measurement device. Thus, preferably a predefined value is adapted to the expected predefined value for the heating element being tested.

Preferably, the heating element is an inductively heatable heating element and comprises at least one susceptor material. More preferably, the heating element is a multi-layer susceptor arrangement.

The heating element, in particular a multilayer susceptor element may have different shapes, for example pin-shaped, rod-shaped or strip-shaped. Preferably, the heating element is an elongate heating element.

Preferably, the multi-layer susceptor arrangement is an elongate multi-layer susceptor arrangement in the form of a strip. Preferably, a first layer of a first susceptor material of the multi-layer susceptor arrangement and a second layer of a second susceptor material of the multi-layer susceptor arrangement are in intimate physical contact with each other, wherein the second susceptor material comprises a Curie temperature of below 500 degree Celsius.

Preferably, the first susceptor material comprise no Curie temperature or may comprises a Curie temperature above 500 degree Celsius.

The first susceptor material is preferably used primarily to heat the susceptor when the susceptor is placed in a fluctuating magnetic field. Any suitable material may be used. For example, the first susceptor material may be aluminium, or may be a ferrous material such as stainless steel. Preferably, first susceptor material comprises or consists of a metal, for example ferritic iron or stainless steel, in particular a grade 410, grade 420 or grade 430 stainless steel.

The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor assembly during operation. Thus, the Curie temperature of the second susceptor material should be below the ignition point of the aerosol-forming substrate. The immediate proximity of the first and second susceptor materials may be of advantage in providing an accurate temperature control.

The first susceptor material is preferably a magnetic material having a Curie temperature that Is above 500 degree Celsius. It is desirable from the point of view of heating efficiency that the Curie temperature of the first susceptor is above any maximum temperature that the susceptor assembly should be capable to be heated to. The Curie temperature of the second susceptor material may preferably be selected to be lower than 400 degree Celsius, preferably lower than 380 degree Celsius, or lower than 360 degree Celsius. It is preferable that the second susceptor material is a magnetic material selected to have a Curie temperature that is substantially the same as a desired maximum heating temperature. The Curie temperature of the second susceptor material may, for example, be in a range between 200 degree Celsius and 400 degree Celsius, or between 250 degree Celsius and 360 degree Celsius.

Thus, when heated, the first and second susceptor materials have the same temperature. The first susceptor material, which may be optimized for the heating of an aerosol-forming substrate when the susceptor arrangement is accommodated in an article, may have a first Curie temperature, which is higher than any predefined maximum heating temperature. Once the susceptor has reached the second Curie temperature, the magnetic properties of the second susceptor material change. At the second Curie temperature the second susceptor material reversibly changes from a ferromagnetic phase to a paramagnetic phase. During the inductive heating this phase-change of the second susceptor material may be detected without physical contact with the second susceptor material. Detection of the phase change may allow control over the heating of the aerosol-forming substrate in real use of the susceptor arrangement. For example, on detection of the phase change associated with the second Curie temperature the inductive heating may be stopped automatically. Thus, an overheating of the aerosol-forming substrate may be avoided, even though the first susceptor material, which is primarily responsible for the heating of the aerosol-forming substrate, has no Curie temperature or a first Curie-temperature which is higher than the maximum desirable heating temperature. After the inductive heating has been stopped the susceptor cools down until it reaches a temperature lower than the second Curie temperature. At this point the second susceptor material regains its ferromagnetic properties again. This phase-change may be detected without contact with the second susceptor material and the inductive heating may then be activated again. Thus, the inductive heating of the susceptor arrangement and thus of an aerosol-forming substrate surrounding the susceptor assembly, may be controlled by a repeated activation and deactivation of the inductive heating device. This temperature control is accomplished by contactless means. Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding. It is preferred that the second susceptor material is present as a dense layer. A dense layer has a higher magnetic permeability than a porous layer, making it easier to detect fine changes at the Curie temperature. If the first susceptor material is optimised for heating of the substrate it may be preferred that there is no greater volume of the second susceptor material than is required to provide a detectable second Curie point.

Suitable material for the second susceptor material may include nickel and certain nickel alloys.

It has been found that a specific material selection of the second susceptor material may reduce undesired effects in the susceptor arrangement occurring during its production due to the impact of the restricted free movement between the various susceptor materials, in particular between various layers, on the magnetostriction, which is difficult to control during the mass production of such susceptor arrangements. In particular, these undesired effects may vary across different locations of the precursor laminate material which a plurality of susceptor arrangements are finally made of. As a result, the magnetic properties may vary between different susceptor arrangements even though being made of the same precursor material.

Therefore, preferably, the second susceptor material comprises or consists of a Ni—Fe-alloy comprising 75 weight percent to 85 weight percent and 10 weight percent to 25 weight percent Fe. More particular, the Ni—Fe-alloy may comprise 79 weight percent to 82 weight percent Ni and 13 weight percent to 15 weight percent Fe. It has been found that Ni—Fe-alloys including Ni and Fe in the above ranges exhibit only weak or even no magnetostriction. As a consequence, the second susceptor material of the second layer experiences no or only at least a reduced modification of its magnetic properties after its processing and throughout its temperature range of operation. This in turn allows for a mass production of multi-layer susceptor arrangements having a second magnetic layer with no or only little variation of its magnetic properties after processing and during subsequent operation.

As used herein, the term “weight percent” or also “percentage by weight” denotes the mass fraction of an element within the alloy which is the ratio of the mass of that respective element to the total mass of a sample of that alloy.

In addition to the main components, the remainder of the Ni—Fe-alloy may comprise one or more of the following elements: Co, Cr, Cu, Mn, Mo, Nb, Si, Ti and V.

As used herein, the symbol Ni stands for the chemical element nickel, the symbol Fe stands for the chemical element iron, the symbol Co stands for the chemical element cobalt, the symbol Cr stands for the chemical element chromium, the symbol Cu stands for the chemical element copper, the symbol Mn stands for the chemical element manganese, the symbol Mo stands for the chemical element molybdenum, the symbol Nb stands for the chemical element niobium, the symbol Si stands for the chemical element silicon, the symbol Ti stands for the chemical element titanium, and the symbol V stands for the chemical element vanadium.

The first layer may have a layer thickness in a range between 20 micrometer and 60 micrometer.

The second layer may have a layer thickness in a range between 4 micrometer and 20 micrometer.

The second material may be intimately coupled to the first material. As used herein, the term “intimately coupled” refers to a mechanical coupling between two susceptor material, in particular susceptor layers, within the susceptor arrangement such that a mechanical force may be transmitted between the two materials, in particular in a direction parallel to a layer structure. The coupling may be a laminar, two-dimensional, areal or full-area coupling, that is, a coupling across the respective opposing surfaces of two layers. The coupling may be direct. In particular, the two material, which are intimately coupled with each other, may be in direct contact with each other. Alternatively, the coupling may be indirect. In particular, the two materials may be indirectly coupled via at least one intermediate material. Preferably, the second layer is arranged upon and intimately coupled to, in particular directly connected with the first layer.

In some embodiments, the multi-layer susceptor arrangement comprises a third layer intimately coupled to the second layer, wherein the third layer comprises a third susceptor material. In this context, the term “intimately coupled” is used in the same way as defined above with regard to the first and second material.

Preferably, the third susceptor material is a protective material configured to at least one of: to avoid aerosol-forming substrate sticking to the surface of the susceptor arrangement, to avoid material diffusion, for example metal migration, from the susceptor materials into the aerosol-forming substrate, to avoid or reduce thermal bending due to differences in thermal dilatation between the materials of the susceptor arrangement, or to protect other materials, in particular the second material from any corrosive influences.

The latter is particularly important, where the susceptor arrangement is embedded in an aerosol-forming substrate of an aerosol-generating article, that is, where the susceptor arrangement is in direct physical contact with aerosol-forming substrate. For this, the third susceptor material preferably comprises or consists of an anti-corrosive material. Advantageously, the anti-corrosive material improves the aging characteristics of those portions of the outer surface of the non-corrosion resistant second susceptor material which are covered by the third susceptor material and thus not directly exposed to the environment.

As used herein, the term “third layer” refers to a layer in addition to the first and second layer that is different from the first and second layer. In particular, any possible oxide layer on a surface of the first or second layer resulting from oxidation of the first or second susceptor material is not to be considered a third layer, in particular not a third layer comprising or consisting of an anti-corrosive material.

Due to this, a multi-layer susceptor arrangement comprises at least two layers having the same coefficient of thermal expansion which results in reduced deformations of the susceptor arrangement through the temperature range of operation. This applies in particular where the susceptor arrangement only comprises the first, second and third layer and where the second layer is symmetrically sandwiched between the first and third layer.

Accordingly, the third susceptor material may comprise a metal, for example ferritic iron, or stainless steel, for example ferritic stainless steel, in particular a 400 series stainless steel such as grade 410 stainless steel, or grade 420 stainless steel, or grade 430 stainless steel, or stainless steel of similar grades. Alternatively, the third susceptor material may comprise or be a suitable non-magnetic, in particular paramagnetic, conductive material, such as aluminum (Al). Likewise, the third material may comprise or be a non-conductive ferrimagnetic material, such as a non-conductive ferrimagnetic ceramic.

It is also possible that the third material comprises or consists of an austenitic stainless steel. Advantageously, due to its paramagnetic characteristics and high electrical resistance, austenitic stainless steel only weakly shields the second layer from the magnetic field to be applied to the first and second susceptor material. As an example, the third layer may comprise or consist of X5CrNi18-10 (according to EN (European Standards) nomenclature, material number 1.4301, also known as V2A steel) or X2CrNiMo17-12-2 (according to EN (European Standards) nomenclature, material number 1.4571 or 1.4404, also known as V4A steel). In particular, the third layer may comprise or consist of one of 301 stainless steel, 304 stainless steel, 304L stainless steel, 316 stainless steel or 316L stainless steel (nomenclature according to SAE steel grades [Society of Automotive Engineers]).

The third material—if present—may be a third susceptor layer having a third layer thickness in range between 2 micrometer and 6 micrometer, in particular between 3 micrometer and 5 micrometer, preferably between 3 micrometer and 4 micrometer.

The layer thickness of the third layer may be in a range of 0.05 to 1.5, in particular 0.1 to 1.25, or 0.95 to 1.05, in particular 1 times a layer thickness of the first layer.

In case of a symmetric or close-to-symmetric layer configuration, the first layer as well as the third layer may have a thickness in range between 2 micrometer and 20 micrometer, in particular between 3 micrometer and 10 micrometer, preferably 3 to 6 micrometer.

The second layer may then have a thickness in range between 5 and 50 micrometer, in particular between 10 and 40 micrometer, preferably 20 to 40 micrometer.

Advantages and features of the invention described either with respect to the testing equipment or with the testing method are applicable vice versa.

The invention is defined in the claims. However, below there is provided a non-exhaustive list of non-limiting examples. Any one or more of the features of these examples may be combined with any one or more features of another example, embodiment, or aspect described herein.

Example Ex1: A non-destructive testing equipment for testing a heating element in an aerosol-generating article, the testing equipment comprising:
a control module comprising a passage for an aerosol-generating article to pass the control module through the passage, the control module further comprising a control circuit and a measurement device;
wherein the control circuit comprises an excitation coil configured to generate an alternating magnetic field within the passage of the control module, and wherein the measurement device is configured to determine values related to a load applied to the control circuit responsive to physical characteristics of the heating element, when the heating element passes the control module through the passage;
wherein the control module is further configured to determine if a determined value of the tested heating element corresponds to a predefined value of a predefined heating element.

Example Ex2: The testing equipment of Example Ex1, wherein the determined value is a value indicative of an apparent electrical resistance of the heating element.

Example Ex3: The testing equipment according to any one of Example Ex1 or Ex2, wherein the measurement device comprises a current measurement device for determining a DC current drawn by the control circuit from a DC power supply of the device, and wherein the measurement device is configured to determine an electrical resistance value of the control circuit from a ratio of the determined DC current to a DC voltage applied to the control circuit.

Example Ex4: The testing equipment according to any one of the preceding Examples, wherein the control circuit of the control module is configured to provide power pulses for powering the excitation coil.

Example Ex5: The testing equipment according to any one of the preceding Examples, wherein the excitation coil is part of an LRC circuit of the measurement device.

Example Ex6: The testing equipment according to any one of the preceding Examples, wherein the control circuit is configured to operate the excitation coil at low power.

Example Ex7: The testing equipment according to Example Ex6, wherein the control circuit is configured to apply a DC voltage in a range between 0.5 V and 3V, preferably 1 V.

Example Ex8: The testing equipment according to any one of the preceding Examples, wherein the control module is configured to output acceptance of the aerosol-forming article, when the determined value of the tested heating element corresponds to the predefined value of the predefined heating element, or output rejection of the aerosol-generating article, when the determined value of the tested heating element does not correspond to the predefined value of the predefined heating element.

Example Ex9: The testing equipment according to any one of the preceding Examples, wherein the excitation coil is arranged in the control module and arranged to surround the passage.

Example Ex10: The testing equipment according to any one of the preceding Examples, wherein the passage in the control module is a through-hole through the control module.

Example Ex11: The testing equipment according to any one of the preceding Examples, further comprising a guide element for guiding the aerosol-generating article to the passage of the control module.

Example Ex12: The testing equipment according to Example Ex11, wherein the guide element comprises a conveyor for conveying the aerosol-generating article to the control module.

Example Ex13: The testing equipment according to Example Ex11, wherein the guide element comprises a slide for guiding the aerosol-generating article on the slide.

Example Ex14: The testing equipment according to any one of Examples Ex11 to Ex13, wherein the guide element comprises converging guides converging versus an opening of the passage.

Example Ex15: The testing equipment according to any one of the preceding Examples, further comprising a reservoir for holding aerosol-generating articles, the reservoir being arranged upstream of the control module.

Example Ex16: The testing equipment according to any one of the preceding Examples, wherein the testing equipment is arranged between article manufacturing components.

Example Ex17: The testing equipment according to Examples Ex16, wherein the manufacturing components are any one of a rod-forming device and a cutting device arranged upstream of the testing equipment and any one of a cutting device, an article storage and an article packaging device arranged downstream of the testing device.

Example Ex18: A non-destructive testing method for testing a heating element in an aerosol-generating article, the method comprising:
providing an aerosol-generating article comprising a heating element;
letting the aerosol-generating article pass an alternating magnetic field of a control circuit without heating the heating element;
determining values related to a load by the heating element applied to the control circuit responsive to physical characteristics of the heating element passing the alternating field of the control circuit; and
comparing a determined value of the tested heating element with a predefined value of a predefined heating element.

Example Ex19: The method of Example Ex18, further comprising accepting the aerosol-generating article, if a difference between the determined value of the tested heating element and the predefined value is within a predefined threshold or rejecting the aerosol-generating article, if a difference between the determined value of the tested heating element and the predefined value exceeds the predefined threshold.

Example Ex20: The method according to any one of Examples Ex18 to Ex19, therein determining values indicative of an apparent electrical resistance of the heating element.

Example Ex21: The method according to any one of Examples Ex18 to Ex20, therein measuring a DC current drawn by the control circuit from a DC power supply, and determining an electric resistance value of the control circuit from a ratio of the determined DC current to a DC voltage applied to the control circuit.

Example Ex22: The method according to any one of Examples Ex18 to Ex21, therein providing power pulses from the control module to the excitation coil.

Example Ex23: The method according to any one of Examples Ex18 to Ex22, therein applying a DC voltage of between 0.5 V and 3V to the control circuit.

Example Ex24: The method according to any one of Examples Ex18 to Ex23, wherein the aerosol-generating article passes the alternating magnetic field with a velocity between 0 m/s and 40 m/s, when being tested.

Example Ex25: The method according to Example Ex24, wherein the aerosol-generating article passes the alternating magnetic field with a velocity between 10 m/s and 30 m/s, when being tested.

Example Ex26: The method according to any one of Examples Ex18 to Ex25, wherein the aerosol-generating article is passing through a center of the excitation coil.

Example Ex27: The method according to Example Ex26, therein guiding the aerosol-generating article to the center of the excitation coil.

Example Ex28: The method according to any one of Examples Ex18 to Ex27, wherein the aerosol-generating article is transported through the alternating magnetic field by transportation means.

Example Ex29: The method according to any one of Examples Ex18 to Ex28, wherein the aerosol-generating article is falling through the alternating magnetic field due to gravitational force.

Example Ex30: The method according to any one of Examples Ex18 to Ex29, further providing a reservoir comprising aerosol-generating articles comprising a heating element and guiding the aerosol-generating articles from the reservoir to the alternating magnetic field.

Example Ex31: The method according to any one of Examples Ex18 to Ex30, wherein the aerosol-generating article is rod-shaped.

Example Ex32: The method according to Example Ex31, wherein the aerosol-generating article is a rod-shaped aerosol-generating substrate comprising the heating element.

Example Ex33: The method according to any one of Examples Ex18 to Ex32, wherein the aerosol-generating article has a final length of a tobacco plug of a consumable being used in an aerosol-generating device.

Example Ex34: The method according to any one of Examples Ex18 to Ex32, wherein the aerosol-generating article has a multiple length of a final length of a tobacco plug of a consumable being used in an aerosol-generating device.

Example Ex35: The method according to any one of Examples Ex18 to Ex34, therein adapting the predefined value of a predefined heating element according a length of the predefined heating element.

Example Ex36: The method according to any one of Examples Ex18 to Ex35, wherein the heating element comprises at least one susceptor material.

Example Ex37: The method according to any one of Examples Ex18 to Ex36, wherein the heating element is a multi-layer susceptor arrangement.

Example Ex38: The method according to Example Ex37, wherein the multi-layer susceptor arrangement is an elongate multi-layer susceptor arrangement in the form of a strip.

Example Ex39: The method according to any one of Examples Ex37 to Ex38, wherein a first layer of a first susceptor material of the multi-layer susceptor arrangement and a second layer of a second susceptor material of the multi-layer susceptor arrangement are in intimate physical contact with each other, wherein the second susceptor material comprises a Curie temperature of below 500 degree Celsius.

Example Ex40: The method according to any one of Example Ex39, wherein the first susceptor material comprises no Curie temperature or comprises a Curie temperature above 500 degree Celsius.

Example Ex41: The method according to any one of Examples Ex39 to Ex40, wherein the first susceptor material comprises or consists of a metal, for example ferritic iron or stainless steel, in particular a grade 410, grade 420 or grade 430 stainless steel.

Example Ex42: The method according to any one of Examples Ex39 to Ex41, wherein the second susceptor material comprises or consists of a Ni—Fe-alloy comprising 75 weight percent to 85 weight percent and 10 weight percent to 25 weight percent Fe.

Example Ex43: The method according to Example Ex42, wherein the Ni—Fe alloy further comprises one or more of the following elements: Co, Cr, Cu, Mn, Mo, Nb, Si, Ti and V.

Example Ex44: The method according to any one of Examples Ex39 to Ex43, wherein the first layer has a layer thickness in a range between 20 micrometer and 60 micrometer.

Example Ex45: The method according to any one of Examples Ex39 to Ex44, wherein the second layer has a layer thickness in a range between 4 micrometer and 20 micrometer.

Example Ex46: The method according to any one of Examples Ex39 to Ex45, wherein the multi-layer susceptor arrangement comprises a third layer intimately coupled to the second layer, wherein the third layer comprises a third susceptor material.

Example Ex47: The method according to Example Ex46, wherein the third susceptor material is at least partly identical to the first susceptor material.

Example Ex48: The method according to any one of Examples Ex46 to Ex47, wherein the third layer comprises or consists of an austenitic stainless steel, in particular one of 301 stainless steel, 304 stainless steel, 316 stainless steel or 316L stainless steel.

Example Ex49: The method according to any one of Examples Ex46 to Ex48, wherein the third layer has a layer thickness in a range between 2 micrometer and 6 micrometer.

Examples will now be further described with reference to the figures in which:

FIG. 1 schematically illustrates an exemplary embodiment of a testing equipment;

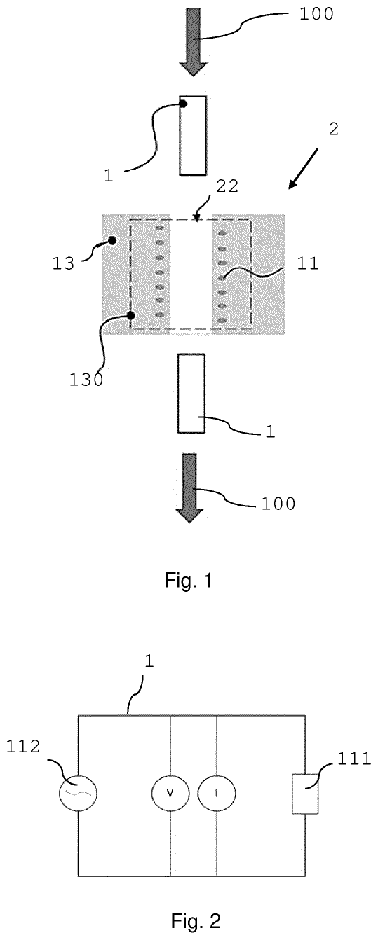

FIG. 2 schematically illustrates the technical operation principle of the testing equipment of FIG. 1;

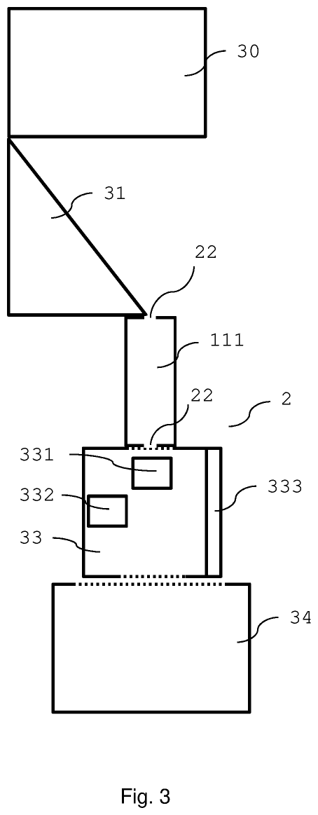

FIG. 3 is a set-up of a testing equipment for measuring falling articles comprising a heating element.

FIG. 1 schematically illustrates an article 1 passing through a testing equipment 2. The article 1 comprises a heating element (not shown), for example an inductively heatable heating element, such as a multi-layer susceptor arrangement. Preferably, the article 1 is a rod-shaped aerosol-generating article comprising the heating element and an aerosol-forming substrate. In particular, the article 1 is a tobacco containing substrate, in which a susceptor is embedded. The article may also be a final consumable, thus a tobacco plug with heating element and additional segments, e.g. a filter element.

In order to check the quality of the heating element in the article 1, the article 1 is passing the testing equipment 2 through passage 22. Depending on the arrangement of the testing equipment 2, the article 1 may be guided through the passage 22 and through the testing equipment 2, for example by means of a conveyor (not shown). The article may also be guided to the passage 22 in the testing equipment 2 and may fall through the passage upon gravitational force, for example vertically downwards as shown in FIG. 1.

A moving direction 100 of the article 1 to be tested may thus be horizontal or vertical or anything in between horizontal and vertical.

A vertical arrangement has a passage that may be arranged exactly vertically or may be arranged to deviate from the exact vertical arrangement by several degrees. For example, a vertical passage may by arranged between 0 degree and 45 degree, preferably, between 0 degree and 30 degree, for example between 0 degree and 15 degree, wherein 0 degree corresponds to the exact vertical arrangement.

The testing equipment 2 comprises a control module 13. Located in the control module 13 is an excitation coil 11, which forms part of a LRC measuring circuit indicated with block 130.

The testing equipment 2 operates differently from a coil module used in a marketed device. In a real device the heating element has to be heated in order to heat the aerosol-forming substrate of the article 1 for aerosol formation.

In the testing equipment 2, the excitation coil 11 is fed with a low voltage, for example with about 1 V.

The LRC circuit is connected to a processor to collect output data from the control module 13.

Results of the test outputted and determined are typically the equivalent resistance of the excitation coil 11 arranged inside the testing equipment 2 when the article 2 and accordingly the heating element is located inside the coil 11.

The control module 13 comprising the passage 22 allows the article to be tested to pass the passage and to carry out the measurement during the passage of the article through the control module 13. This allows for a sample testing in a fast process. It is possible to analyze a high number of articles at high speed, for example at article velocities passing the passage 22 at about 10 m/s to 30 m/s. The velocity of the article 1 may be made dependent on the capacity of the measuring device.

The basic feedback provided by testing equipment 2 is to verify that all tested articles have a similar response in terms of equivalent resistance recorded in the equipment.

Since the testing equipment 2 is a non-destructive testing, the tested articles 1 can still be used after the testing. For this reason, the testing equipment 2 is suitable to be arranged along a manufacturing line of articles, where defective articles can easily and in a fast way be sorted out.

In FIG. 2, the basic technical operating principle of the measurement part of the testing equipment 2 is schematically illustrated. The load 111 is representative of the impedance produced by a system comprising the excitation coil 11 arranged in the control module 13 and the heating element, in particular a susceptor, located in the article 1 to be tested.

The system sends a signal 112 and then measures the resulting voltage V and current I that is absorbed by the control circuit. By knowing the characteristics of the excitation coil 11, it is possible to obtain a measurement of the physical properties of the heating element.

FIG. 3 schematically shows a set-up of a testing equipment 2, adapted to measure falling articles 1 passing through the testing equipment 2.

A reservoir 30 in the form of a hopper contains a plurality of articles to be tested, for example elongate sticks carrying a susceptor element to be tested. Preferably, the hopper may contain a few hundred stick, for example 200 to 300 sticks. The sticks may be final consumables comprising an element comprising a susceptor arrangement or may be rods mainly being tobacco rods with a susceptor arrangement arranged inside the tobacco rod.

From the hopper, the articles 1 fall downwards and are positioned along a vertical line within the slide assembly 31 arranged below the reservoir 30. From the slide assembly 31, articles reach the testing equipment 2. The slide assembly 31 is positioned such that the falling articles are guided to the passage 22 in the testing equipment. The tested articles leave the passage 22 and pass through measuring and indicator portion 33 and subsequently into a container 34 collecting the articles.

The measuring and indicator portion 33 comprises sensor 110, a stopper 332 and indicator lights 333.

The indicator lights 333 may indicate, for example, the status of the testing equipment or if the tested articles are acceptable or defective by changing light colour. For example, one colour may indicate that the apparatus is ready for a measurement, that the measurement is ongoing, that a measured article is within product tolerances or that an article is outside product tolerances.

The sensor 110 may be a control module 13 as described above in FIG. 1 to measure the articles passing through the testing equipment, wherein an equivalent electrical resistance of the susceptor element is measured.

The stopper 332 maintains an article in a measuring position inside the sensor 110. The stopper 332 stops the article when the article falls through the testing equipment and releases the article after the measurement for the article to end up in the container 34.

Preferably, test conditions are kept constant for an entire measurement cycle, for example over a certain number of tested articles or over a certain time of testing, for example over 24 hours. For example, test conditions comprise about 20 to 24 degree Celsius and about 40 to 60 percent relative humidity. An acceptable deviation from a desired electrical resistance is for example plus or minus 40 milliohms with an electrical resistance of between 300 to 450 milliohm of the susceptor element. The deviation is preferably determined relative to an average value over e.g. five measurements.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. A non-destructive testing equipment for testing a heating element in an aerosol-generating article, the testing equipment comprising:
a control module comprising a passage for an aerosol-generating article to pass the control module through the passage, the control module further comprising a control circuit and a measurement device;
wherein the control circuit comprises an excitation coil configured to generate an alternating magnetic field within the passage of the control module, and wherein the measurement device is configured to determine values related to a load applied to the control circuit responsive to physical characteristics of the heating element, when the heating element passes the control module through the passage;
wherein the control module is further configured to determine if a determined value of the tested heating element corresponds to a predefined value of a predefined heating element.

2. The testing equipment according to claim 1, wherein the determined value is a value indicative of an apparent electrical resistance of the heating element.

3. The testing equipment according to claim 1, wherein the excitation coil is part of an LRC circuit of the measurement device.

4. The testing equipment according to claim 1, wherein the control circuit is configured to operate the excitation coil at low power.

5. The testing equipment according to claim 4, wherein the control circuit is configured to apply a DC voltage in a range between 0.5 V and 3V, preferably 1 V.

6. The testing equipment according to claim 1, wherein the excitation coil is arranged in the control module and arranged to surround the passage.

7. The testing equipment according to claim 1, further comprising a guide element for guiding the aerosol-generating article to the passage of the control module.

8. The testing equipment according to claim 7, wherein the guide element comprises a slide for guiding the aerosol-generating article on the slide.

9. A non-destructive testing method for testing a heating element in an aerosol-generating article, the method comprising:
providing an aerosol-generating article comprising a heating element;
letting the aerosol-generating article pass an alternating magnetic field of a control circuit without heating the heating element;
determining values related to a load by the heating element applied to the control circuit responsive to physical characteristics of the heating element passing the alternating field of the control circuit; and
comparing a determined value of the tested heating element with a predefined value of a predefined heating element.

10. The method according to claim 9, further comprising accepting the aerosol-generating article, if a difference between the determined value of the tested heating element and the predefined value is within a predefined threshold or rejecting the aerosol-generating article, if a difference between the determined value of the tested heating element and the predefined value exceeds the predefined threshold.

11. The method according to claim 9, therein applying a DC voltage of between 0.5 V and 3V to the control circuit.

12. The method according to claim 9, wherein the aerosol-generating article passes the alternating magnetic field with a velocity between 0 m/s and 40 m/s, when being tested.

13. The method according to claim 12, wherein the aerosol-generating article passes the alternating magnetic field with a velocity between 10 m/s and 30 m/s, when being tested.

14. The method according to claim 9, wherein the aerosol-generating article is falling through the alternating magnetic field due to gravitational force.

15. The method according to claim 9, wherein the heating element is a multi-layer susceptor arrangement.
